(19) United States
(12) Patent Application Publication
(10) Pub. No.: US 2021/0378212 A1
(43) Pub. Date: Dec. 9, 2021

(54) Handheld Pet Grooming Scratcher

(71) Applicant: Bearback, LLC, Milton, GA (US)

(72) Inventor: JP Duvall, Milton, GA (US)

(73) Assignee: Bearback, LLC, Milton, GA (US)

(21) Appl. No.: 16/897,083

(22) Filed: Jun. 9, 2020

(51) Int. Cl. A01K 13/00

(52) U.S. Cl. CPC A01K 13/002

(57) ABSTRACT

A handheld pet grooming scratcher has a first shaft coupled to a handle on a first end and a second shaft coupled to the first shaft on a second end of the first shaft. The animal comb further has a head coupled to the second shaft, the head having a substantially oval-shaped plate and a plurality of finger-like projections. The plurality of finger-like projections extends from the substantially oval-shaped plate downwardly with a first radius of curvature relative to the substantially oval-shaped plate.

### BACKGROUND OF THE DISCLOSURE

Many individuals share their lives with pets. Often an individual will may desire to brush, scratch, comb, pat or massage his/her pet. The individual may brush, scratch, comb, pat or massage the animal's back, stomach, or other part of the animal's body. In such situations, the individual typically uses his/her hands to scratch, pet, comb or massage the animal.

Regarding brushing the individual's animal, there are brushes with which a user may use to brush the animal's fur. A typical animal brush comprises a handle attached to a head. The head comprises a plurality of bristles. These types of brushes are typically used to brush and smooth out the animal's fur.

### BRIEF DESCRIPTION OF THE DRAWINGS

The system is described with reference to the accompanying drawings. In the drawings, like reference numbers indicate identical or functionally similar elements. Additionally, the left-most digit(s) of a reference number identifies the drawing in which the reference number first appears.

FIG. 1 is a top perspective view of a handheld pet grooming scratcher in its contracted position in accordance with an embodiment of the present disclosure.

FIG. 2 is a bottom perspective view of the handheld pet grooming scratcher in its contracted position as shown in FIG. 1.

FIG. 3 is a top, plan view of the handheld pet grooming scratcher depicted in FIG. 1.

FIG. 4 is a bottom, plan view of the handheld pet grooming scratcher depicted in FIG. 1.

FIG. 5 is a side view of the handheld pet grooming scratcher depicted in FIG. 1.

FIG. 6 is a comb end view of the handheld pet grooming scratcher depicted in FIG. 1.

FIG. 7 is a handle end view of the handheld pet grooming scratcher depicted in FIG. 1.

FIG. 8 is a top perspective view of the handheld pet grooming scratcher depicted in FIG. 1 in its protracted position.

### DETAILED DESCRIPTION

The detailed description describes an exemplary handheld pet grooming scratcher in accordance with an embodiment of the present disclosure. The handheld pet grooming scratcher comprises a head on a first end. The head comprises a substantially oval plate that is contiguous with a plurality of finger-like protrusions. The finger-like protrusions curve downward from the substantially oval plate at a radius of curvature. On the opposing, second end is a handle. Interposed between the head on the first end and the handle on opposing, second end is a first shaft that is coupled to the handle and a second shaft that has a smaller circumference that the first shaft. In its contracted state, the second shaft slides into the first shaft, and the first shaft and second shaft are coupled via a shaft-turn that releases the second shaft from the first shaft so that the handheld pet grooming scratcher can be protracted. The second shaft is rigidly coupled to the head via a substantially cylindrical connector.

In use, an individual may grasp the handle and run the finger-like protrusions over an animal's fur to brush, scratch, comb, pat or massage the animal's back, stomach, or other part of the animal's body in its contracted state. The individual may also actuate the shaft-turn and move the second shaft outward so that the handheld pet grooming scratcher is in its protracted state. This may allow the individual to more easily reach his/her animal's fur.

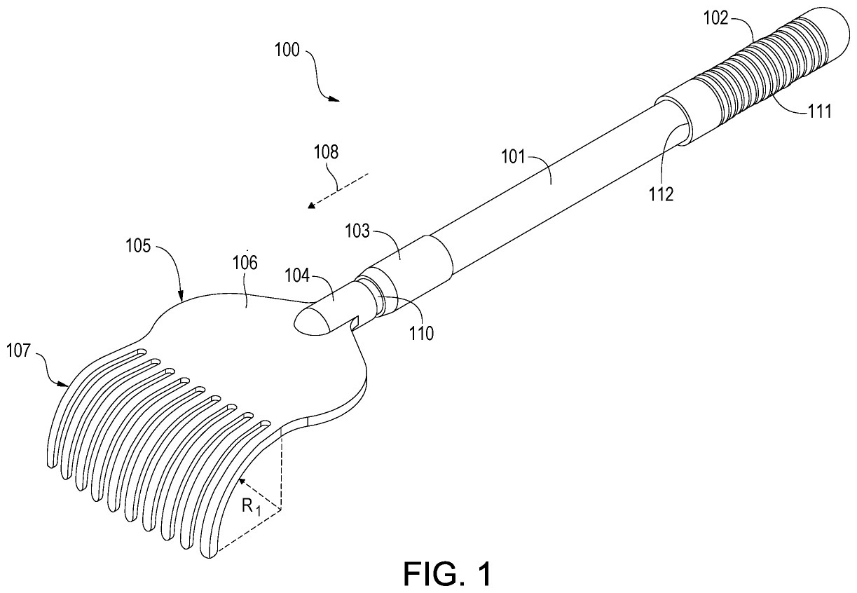

FIG. 1 depicts a top perspective view of a handheld pet grooming scratcher 100 in its contracted state in accordance with an embodiment of the present disclosure. Note that FIG. 1 shows the handheld pet grooming scratcher 100 in its contracted state. That is, the handheld pet grooming scratcher 100 is shorter than if the handheld pet grooming scratcher 100 is in its protracted shape, which is described further herein. The handheld pet grooming scratcher 100 may be comprised of any flexible-type material, such as a semi-flexible plastic nylon blend that flexes when handheld pet grooming scratcher is used on an animal.

The handheld pet grooming scratcher 100 comprises a handle 102, a first shaft 101, a shaft-turn 103, a connector 104 and a head 105. The handle 102 is substantially cylindrical and is coupled to the first shaft 101. For example, the handle 102 may have an opening 112. Note that the handle 102 may be hollow, and the first shaft 101 inserts into opening 112 and into the handle 102. 100. In one embodiment, the handle 102 is comprised of a material that allows easy gripping. For example, the handle 102 may be comprised of rubber. The desired material is one for ease and comfort while in use.

The first shaft 101 is substantially cylindrical. Further, the first shaft 101 is hollow. The first shaft 101 is a first circumference. Note that the first circumference is such that the first shaft 101 may insert into the handle 102. That is, the first circumference is slightly less than the circumference of the opening 112.

The second shaft 110 is substantially cylindrical. The second shaft 110 is a second circumference. The second circumference is smaller than the first circumference of the first shaft 101. Thus, the second shaft 110 fully inserts into the first shaft 101 while the handheld pet grooming scratcher 100 is in its contracted state (as shown). So, in its contracted state it is shorter than in its protracted state, which is described further herein.

The first shaft 101 and the second shaft 110 are coupled via the shaft-turn 103. In operation, an individual (not shown) turns the shaft-turn 103, which releases the second shaft 110 so that it can be protracted in a direction indicated by reference arrow 108, making the handheld pet grooming scratcher 100 longer.

The second shaft 110 is rigidly coupled to a head connector 104. The head connector 104 is fixedly coupled to an end of the second shaft 110. Further, the head connector 104 is fixedly coupled to a head 105 of the handheld pet grooming scratcher 100.

The head 105 comprises a substantially oval-shaped plate 106. The plate 106 may be comprised of any type of nonflexible material. For example, the plate 106 may be comprised of a hard plastic, wood, or metal.

The substantially oval-shaped plate 106 is contiguous with a plurality of finger-like projections 107. In one embodiment, the plurality of finger-like projections 107 are integral with the substantially oval-shaped plate 106. In another embodiment, the plurality of finger-like projections 107 are separable from the substantially over-shaped plate 106 such that the finger-like projections 107 can be removed from the substantially oval-shaped plate 106.

The plurality of finger-like projections 107 extend from the oval-shaped plate 106 curving downward. In this regard, the plurality of finger-like projections 107 have a radius of curvature R₁ relative to the substantially oval-shaped plate 106. This radius of curvature allows easier access to an animal's body (not shown) when brushing, combing, scratching, petting, or massaging the animal (not shown). Note that in one embodiment, the head 105 is screwed onto the second shaft 110 so that the head 105 is replaceable.

In use, an individual (not shown) grasps the handle 102. The individual contacts that part of the animal's body the user wishes to brush, scratch, comb, pat or massage with the plurality of finger-like projections 107. The individual then moves the handheld pet grooming scratcher 100 in a back and forth manner to brush, scratch, comb, pat or massage the animal's body.

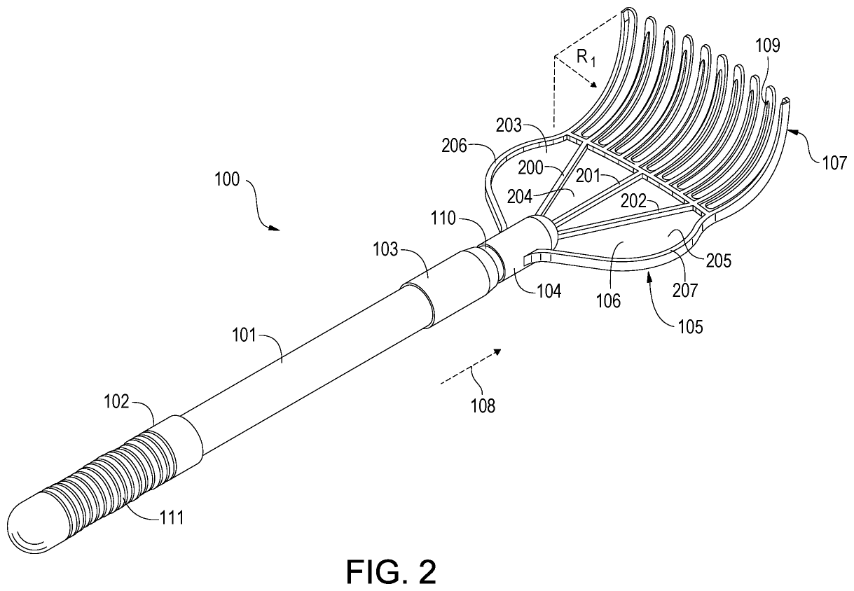

FIG. 2 depicts a bottom perspective view of the handheld pet grooming scratcher 100 in its contracted state in accordance with an embodiment of the present disclosure. Note that FIG. 2 shows the handheld pet grooming scratcher 100 in its contracted state. That is, the handheld pet grooming scratcher 100 is shorter than if the handheld pet grooming scratcher 100 is in its protracted shape, which is described further herein. The handheld pet grooming scratcher 100 may be comprised of any nonflexible-type material, such as a hard plastic, wood, or metal.

The handheld pet grooming scratcher 100 comprises the handle 102, the first shaft 101, the shaft-turn 103, the connector 104 and the head 105. The handle 102 is substantially cylindrical and is coupled to the first shaft 101, as described above. Further, the handle 102 comprises the plurality of rings 111. The rings 111 allow a better grasp of the handheld pet grooming scratcher 100. In one embodiment, the handle 102 is comprised of rubber.

The first shaft 101 is substantially cylindrical. Further, the first shaft 101 is hollow. The first shaft 101 is a first circumference. Note that the first circumference is such that the first shaft 101 may insert into the handle 102. That is, the first circumference is slightly less than the circumference of the opening 112.

The second shaft 110 is substantially cylindrical. The second shaft 110 is a second circumference. The second circumference is smaller than the first circumference of the first shaft 101. Thus, the second shaft 110 fully inserts into the first shaft 101 while the handheld pet grooming scratcher 100 is in its contracted state (as shown). So, in its contracted state it is shorter than in its protracted state, which is described further herein.

The first shaft 101 and the second shaft 110 are coupled via the shaft-turn 103. In operation, an individual (not shown) turns the shaft-turn 103, which releases the second shaft 110 so that it can be protracted in a direction indicated by reference arrow 108, making the handheld pet grooming scratcher 100 longer.

On the underside, the second shaft 110 is rigidly coupled to a head connector 104. The head connector 104 is fixedly coupled to an end of the second shaft 110. Further, the head connector 104 is fixedly coupled to the head 105 of the handheld pet grooming scratcher 100.

The head 105 comprises a substantially oval-shaped plate 106. The plate 106 may be comprised of any type of nonflexible material. For example, the plate 106 may be comprised of a hard plastic, wood, or metal.

The substantially oval-shaped plate 106 has a support system that comprises a right ledge 207 and a left ledge 108 that are contiguous with edges of and protrude from the substantially oval-shaped plate 106. Further, the support system comprises braces 200, 201, and 202. The braces 200, 201, and 202 extend from the head connector 104 to the plurality of finger-like protrusions 107 and are integral with or coupled to the underside of the substantially oval-shaped plate 106. The braces 200, 201, and 202 and the ledges 206 and 207 create indented areas 203, 204, and 205 that lack substance. Thus, the indented areas 203, 204, and 205 ensure that the head 105 is light and easy to use to brush, scratch, comb, pet, or massage animal's body. Further, the ledges 206 and 207 and the braces 200, 201, and 202 provide support to the underside of the substantially oval-shaped plate 106.

The substantially oval-shaped plate 106 is contiguous with the plurality of finger-like projections 107 as described above. The plurality of finger-like projections 107 extend from the oval-shaped plate 106 curving upward (when viewing the underside of the handheld pet grooming scratcher 100). In this regard, the plurality of finger-like projections 107 have a radius of curvature R₁ relative to the substantially oval-shaped plate 106. This radius of curvature allows easier access to an animal's body (not shown) when brushing, combing, scratching, petting, or massaging the animal (not shown).

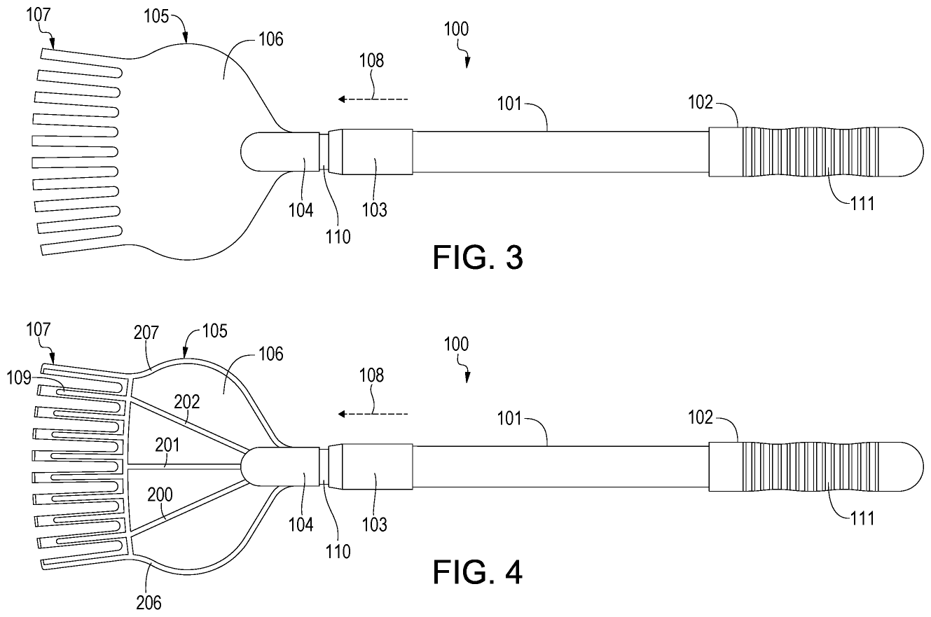

FIG. 3 is a top, plan view of the handheld pet grooming scratcher 100. In FIG. 3 the handheld pet grooming scratcher 100 is in its contracted state. That is, it is shorter than it would be in its protracted state.

The handheld pet grooming scratcher 100 comprises the handle 102, the first shaft 101, the shaft-turn 103, the connector 104 and the head 105. The handle 102 is substantially cylindrical and is coupled to the first shaft 101, as described above. Further, the handle 102 comprises the plurality of rings 111. The rings 111 allow a better grasp of the handheld pet grooming scratcher 100. In one embodiment, the handle 102 is comprised of rubber.

The first shaft 101 is substantially cylindrical. Further, the first shaft 101 is hollow. The first shaft 101 is a first circumference. Note that the first circumference is such that the first shaft 101 may insert into the handle 102. That is, the first circumference is slightly less than the circumference of the opening 112.

The second shaft 110 is substantially cylindrical. The second shaft 110 is a second circumference. The second circumference is smaller than the first circumference of the first shaft 101. Thus, the second shaft 110 fully inserts into the first shaft 101 while the handheld pet grooming scratcher 100 is in its contracted state (as shown). So, in its contracted state it is shorter than in its protracted state, which is described further herein.

The first shaft 101 and the second shaft 110 are coupled via the shaft-turn 103. In operation, an individual (not shown) turns the shaft-turn 103, which releases the second shaft 110 so that it can be protracted in a direction indicated by reference arrow 108, making the handheld pet grooming scratcher 100 longer.

The head 105 comprises a substantially oval-shaped plate 106. The substantially oval-shaped plate 106 is contiguous with the plurality of finger-like projections 107 as described above. The plurality of finger-like projections 107 extend from the oval-shaped plate 106 curving downward. In this regard, the plurality of finger-like projections 107 have a radius of curvature R₁ relative to the substantially oval-shaped plate 106, as described above.

FIG. 4 is a bottom, plan view of the handheld pet grooming scratcher 100 in its contracted state in accordance with an embodiment of the present disclosure. Note that FIG. 4 shows the handheld pet grooming scratcher 100 in its contracted state. That is, the handheld pet grooming scratcher 100 is shorter than if the handheld pet grooming scratcher 100 is in its protracted shape, which is described further herein.

The handheld pet grooming scratcher 100 comprises the handle 102, the first shaft 101, the shaft-turn 103, the connector 104 and the head 105. The handle 102 is substantially cylindrical and is coupled to the first shaft 101, as described above. Further, the handle 102 comprises the plurality of rings 111. The rings 111 allow a better grasp of the handheld pet grooming scratcher 100.

The first shaft 101 is substantially cylindrical. Further, the first shaft 101 is hollow. The first shaft 101 is a first circumference. Note that the first circumference is such that the first shaft 101 may insert into the handle 102. That is, the first circumference is slightly less than the circumference of the opening 112.

The second shaft 110 is substantially cylindrical. The second shaft 110 is a second circumference. The second circumference is smaller than the first circumference of the first shaft 101. Thus, the second shaft 110 fully inserts into the first shaft 101 while the handheld pet grooming scratcher 100 is in its contracted state (as shown). So, in its contracted state it is shorter than in its protracted state, which is described further herein.

The first shaft 101 and the second shaft 110 are coupled via the shaft-turn 103. In operation, an individual (not shown) turns the shaft-turn 103, which releases the second shaft 110 so that it can be protracted in a direction indicated by reference arrow 108, making the handheld pet grooming scratcher 100 longer.

On the underside of the handheld pet grooming scratcher 100, the second shaft 110 is rigidly coupled to a head connector 104. The head connector 104 is fixedly coupled to an end of the second shaft 110. Further, the head connector 104 is fixedly coupled to the head 105 of the handheld pet grooming scratcher 100.

The head 105 comprises a substantially oval-shaped plate 106. The plate 106 may be comprised of any type of nonflexible material. For example, the plate 106 may be comprised of a hard plastic, wood, or metal.

The substantially oval-shaped plate 106 has a support system that comprises the right ledge 207 and the left ledge 108 that are contiguous with edges of and protrude from the substantially oval-shaped plate 106. Further, the support system comprises the braces 200, 201, and 202. The braces 200, 201, and 202 extend from the head connector 104 to the plurality of finger-like protrusions 107 and are integral with or coupled to the underside of the substantially oval-shaped plate 106. The braces 200, 201, and 202 and the ledges 206 and 207 create indented areas 203, 204, and 205 that lack substance. Thus, the indented areas 203, 204, and 205 ensure that the head 105 is light and easy to use to brush, scratch, comb, pet, or massage animal's body. Further, the ledges 206 and 207 and the braces 200, 201, and 202 provide support to the underside of the substantially oval-shaped plate 106.

The substantially oval-shaped plate 106 is contiguous with the plurality of finger-like projections 107 as described above. The plurality of finger-like projections 107 extend from the oval-shaped plate 106 curving upward (when viewing the underside of the handheld pet grooming scratcher 100).

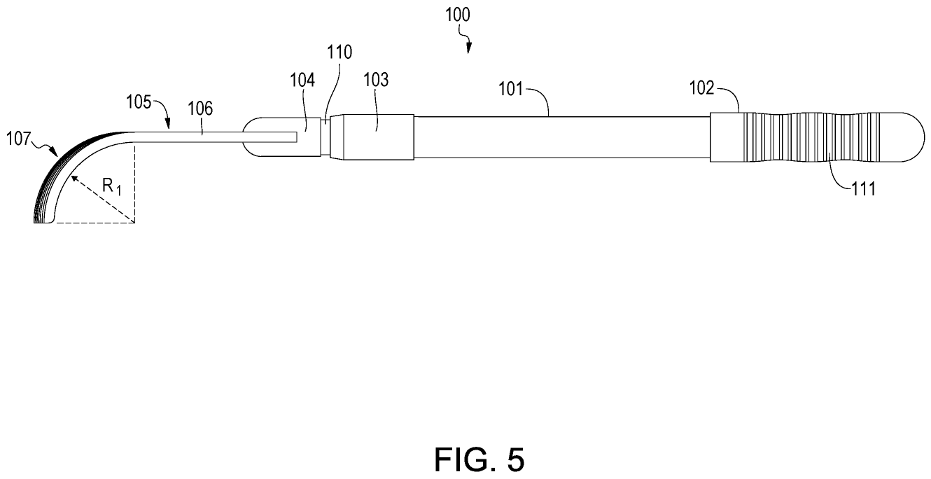

FIG. 5 is a side, plan view of the handheld pet grooming scratcher 100 in its contracted state in accordance with an embodiment of the present disclosure. Note that FIG. 5 shows the handheld pet grooming scratcher 100 in its contracted state. That is, the handheld pet grooming scratcher 100 is shorter than if the handheld pet grooming scratcher 100 is in its protracted shape, which is described further herein.

The handheld pet grooming scratcher 100 comprises the handle 102, the first shaft 101, the shaft-turn 103, the connector 104 and the head 105. The handle 102 is substantially cylindrical and is coupled to the first shaft 101. Further, the handle 102 comprises a plurality of rings 111. The rings 111 allow a better grasp of the handheld pet grooming scratcher 100.

The first shaft 101 is substantially cylindrical. Further, the first shaft 101 is hollow. The first shaft 101 is a first circumference. Note that the first circumference is such that the first shaft 101 may insert into the handle 102. That is, the first circumference is slightly less than the circumference of the opening 112.

The second shaft 110 is substantially cylindrical. The second shaft 110 is a second circumference. The second circumference is smaller than the first circumference of the first shaft 101. Thus, the second shaft 110 fully inserts into the first shaft 101 while the handheld pet grooming scratcher 100 is in its contracted state (as shown). So, in its contracted state it is shorter than in its protracted state, which is described further herein.

The first shaft 101 and the second shaft 110 are coupled via the shaft-turn 103. In operation, an individual (not shown) turns the shaft-turn 103, which releases the second shaft 110 so that it can be protracted in a direction indicated by reference arrow 108, making the handheld pet grooming scratcher 100 longer.

The second shaft 110 is rigidly coupled to the head connector 104. The head connector 104 is fixedly coupled to an end of the second shaft 110. Further, the head connector 104 is fixedly coupled to the head 105 of the handheld pet grooming scratcher 100.

The head 105 comprises a substantially oval-shaped plate 106. The plate 106 may be comprised of any type of nonflexible material. For example, the plate 106 may be comprised of a hard plastic, wood, or metal.

The substantially oval-shaped plate 106 is contiguous with a plurality of finger-like projections 107. The plurality of finger-like projections 107 extend from the oval-shaped plate 106 curving downward. In this regard, the plurality of finger-like projections 107 have a radius of curvature R₁ relative to the substantially oval-shaped plate 106. This radius of curvature allows easier access to an animal's body (not shown) when brushing, combing, scratching, petting, or massaging the animal (not shown).

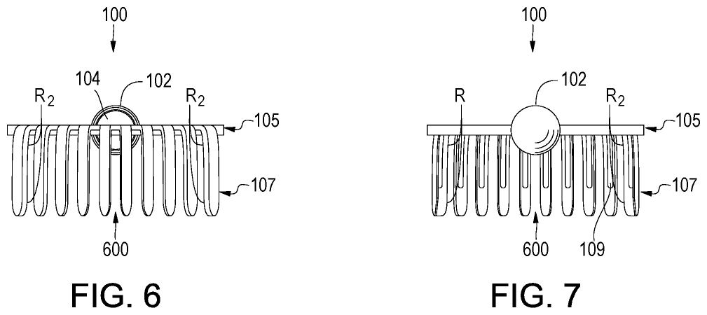

FIG. 6 is an end view of the handheld pet grooming scratcher 100 taken at the end comprising the plurality finger-like projections 107. The second shaft 110 (FIG. 1) is coupled to the head 105. The head 105 comprises the substantially oval-shaped plate 106 (FIG. 1).

The plurality of finger-like projections 107 extend from the substantially over-shaped plate 106. As described above, the plurality of finger-like projections extends outwardly and downwardly relative to the substantially oval-shaped plate 106.

In addition, the plurality of finger-like projections 107 curve outwardly from a center 600 of the plurality of finger-like projections 107. In this regard, the plurality of finger-like projections 107 curve outwardly to the right of center 600 with a radius of curvature R₂. Also, the plurality of finger-like projections 107 curve outwardly to the left of center 600 with a radius of curvature R₂.

FIG. 7 is an end view of the handheld pet grooming scratcher 100 taken at the end comprising the handle 102. The first shaft 101 (FIG. 1) is coupled to the handle 102.

The plurality of finger-like projections 107 extend from the substantially over-shaped plate 106 (FIG. 1). As described above, the plurality of finger-like projections extends outwardly and downwardly relative to the substantially oval-shaped plate 106.

In addition, the plurality of finger-like projections 107 curve outwardly from a center 600 of the plurality of finger-like projections 107. In this regard, the plurality of finger-like projections 107 curve outwardly to the right of center 600 with a radius of curvature R₂. Also, the plurality of finger-like projections 107 curve outwardly to the left of center 600 with a radius of curvature R₂.

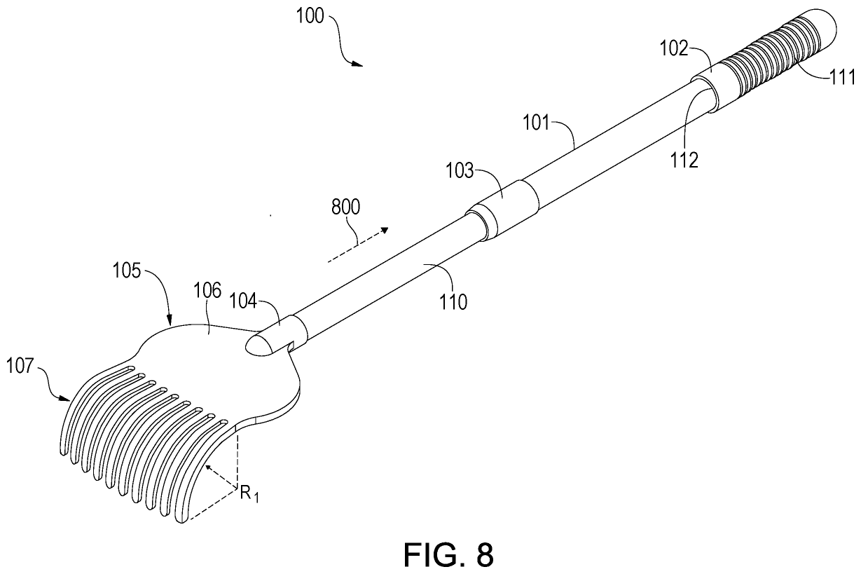

FIG. 8 depicts a top perspective view of a handheld pet grooming scratcher 100 in its protracted state in accordance with an embodiment of the present disclosure. Note that FIG. 8 shows the handheld pet grooming scratcher 100 in its protracted state. That is, the handheld pet grooming scratcher 100 is longer than if the handheld pet grooming scratcher 100 is in its contracted shape, which is described above.

The handheld pet grooming scratcher 100 comprises the handle 102, the first shaft 101, the shaft-turn 103, the connector 104 and the head 105. The handle 102 is substantially cylindrical and is coupled to the first shaft 101. Further, the handle 102 comprises a plurality of rings 111. The rings 111 allow a better grasp of the handheld pet grooming scratcher 100.

The first shaft 101 is substantially cylindrical. Further, the first shaft 101 is hollow. The first shaft 101 is a first circumference. Note that the first circumference is such that the first shaft 101 may insert into the handle 102. That is, the first circumference is slightly less than the circumference of the opening 112.

The second shaft 110 is substantially cylindrical. The second shaft 110 is a second circumference. The second circumference is smaller than the first circumference of the first shaft 101. Thus, the second shaft 110 fully inserts into the first shaft 101 while the handheld pet grooming scratcher 100 is in its contracted state, and slides from the first shaft 101 when in its protracted stated. So, in its protracted state it is longer than in its contracted state, which is described above.

The first shaft 101 and the second shaft 110 are coupled via the shaft-turn 103. In operation, an individual (not shown) turns the shaft-turn 103, which releases the second shaft 110 so that it can be contracted in a direction indicated by reference arrow 800, making the handheld pet grooming scratcher 100 shorter.

The second shaft 110 is rigidly coupled to a head connector 104. The head connector 104 is fixedly coupled to an end of the second shaft 110. Further, the head connector 104 is fixedly coupled to the head 105 of the handheld pet grooming scratcher 100.

The head 105 comprises a substantially oval-shaped plate 106. The substantially oval-shaped plate 106 is contiguous with a plurality of finger-like projections 107. The plurality of finger-like projections 107 extend from the oval-shaped plate 106 curving downward. In this regard, the plurality of finger-like projections 107 have a radius of curvature R₁ relative to the substantially oval-shaped plate 106. This radius of curvature R₁ allows easier access to an animal's body (not shown) when brushing, combing, scratching, petting, or massaging the animal (not shown).

What I claim is:

1. A handheld pet grooming scratcher, comprising:
a first shaft coupled to a handle on a first end;
a second shaft having a first end, the first end coupled to the first shaft on a second end of the first shaft;
a head coupled to the second shaft, the head comprising a substantially oval-shaped plate and a plurality of finger-like projections, the plurality of finger-like projections extending from the substantially oval-shaped plate downwardly with a first radius of curvature relative to the substantially oval-shaped plate.

2. The handheld pet grooming scratcher of claim 2, where the first shaft is moveably coupled to the second shaft so that the second shaft may be extending making the handheld pet grooming scratcher longer.

3. The handheld pet grooming scratcher of claim 1, wherein the first shaft has a first circumference and the second shaft has a second circumference, wherein the first circumference is greater than the second circumference so that the second shaft is movably coupled to the first shaft.

4. The handheld pet grooming scratcher of claim 2, further comprising a shaft-turn, the shaft-turn coupling the first shaft to the second shaft such that when the shaft-turn is actuated, the second shaft may be slid out from the first shaft.

5. The handheld pet grooming scratcher of claim 1, wherein the handle is hollow and comprises an opening.

6. The handheld pet grooming scratcher of claim 5, wherein the first shaft is coupled to the handle by inserted the first shaft into the opening of the handle.

7. The handheld pet grooming scratcher of claim 1, wherein the plurality of finger-like protrusions comprises a center.

8. The handheld pet grooming scratcher of claim 7, wherein the plurality of finger-like protrusions to the right of center curve outwardly relative to the center with a second radius of curvature.

9. The handheld pet grooming scratcher of claim 8, wherein the plurality of finger-like protrusions to the left of center curve outwardly relative to the center with the second radius of curvature.

10. The handheld pet grooming scratcher of claim 1, further comprising a head connector.

11. The handheld pet grooming scratcher of claim 10, wherein a first end of the head connector is rigidly affixed to a second end of the second shaft.

12. The handheld pet grooming scratcher of claim 11, wherein a second end of the head connector is rigidly affixed to the substantially oval-shaped plate.

13. The handheld pet grooming scratcher of claim 1, wherein an underside of the substantially oval-shaped plate comprises a support system.

14. The handheld pet grooming scratcher of claim 13, wherein the support system comprises a first ledge on a first edge of a first side of the substantially oval-shaped plate.

15. The handheld pet grooming scratcher of claim 14, wherein the first ledge is integral with an extends from the first edge of the substantially oval-shaped plate.

16. The handheld pet grooming scratcher of claim 15, further comprising at least one brace that extends from a head connector to the plurality of finger-like protrusions.

17. The handheld pet grooming scratcher of claim 16, wherein the at least one brace is integral with and extends from the underside of the substantially oval-shaped plate.

18. The handheld pet grooming scratcher of claim 1, wherein the head is screwed onto the second shaft for ease of removeable and replacement.
